(19) United States
(12) Patent Application Publication
(10) Pub. No.: US 2013/0113687 A1
(43) Pub. Date: May 9, 2013

(54) ACTIVE MATRIX ORGANIC LIGHT EMITTING DIODE PIXEL CIRCUIT AND OPERATING METHOD THEREOF

(71) Applicants: Po-Hsin LIN, HSINCHU (TW); Chi-Liang WU, HSINCHU (TW); Chin-Wen LIN, HSINCHU (TW); Ted-Hong SHINN, HSINCHU (TW)

(72) Inventors: Po-Hsin LIN, HSINCHU (TW); Chi-Liang WU, HSINCHU (TW); Chin-Wen LIN, HSINCHU (TW); Ted-Hong SHINN, HSINCHU (TW)

(73) Assignee: E INK HOLDINGS INC., HSINCHU (TW)

(21) Appl. No.: 13/610,888

(22) Filed: Sep. 12, 2012

Related U.S. Application Data
(60) Provisional application No. 61/554,990, filed on Nov. 3, 2011.
(60) Provisional application No. 61/581,094, filed on Dec. 29, 2011.

(30) Foreign Application Priority Data
May 21, 2012 (TW) 101118021

(51) Int. Cl. G09G 3/32

(52) U.S. Cl. 345/76

(57) ABSTRACT

An active matrix organic light emitting diode pixel circuit includes an organic light emitting diode, a driving circuit, a switching circuit and a capacitor. In a charge state, by controlling the switching circuit, a first end of the capacitor is electrically coupled to a signal input terminal, and a second end of the capacitor is electrically coupled to a first power source. In a compensation state, by controlling the switching circuit, the first end of the capacitor is electrically coupled to the signal input terminal, and the second end of the capacitor is electrically coupled to an anode of the organic light emitting diode. In an emission state, by controlling the switching circuit, the first end of the capacitor is electrically coupled to the driving circuit, and the second end of the capacitor is electrically coupled to the driving circuit and the anode of the organic light emitting diode.

### RELATED APPLICATIONS

This application claims priority to U.S. Provisional Application Ser. No. 61/554,990, filed Nov. 3, 2011, U.S. Provisional Application Ser. No. 61/581,094, filed Dec. 29, 2011, and Taiwan Application Serial Number 101118021, filed May 21, 2012, the disclosures of which are incorporated herein by reference in their entireties.

### BACKGROUND

1. Field of Invention

The present invention relates to an organic light emitting diode pixel circuit and an operating method thereof. More particularly, the present invention relates to an active matrix organic light emitting diode pixel circuit and an operating method thereof.

2. Description of Related Art

Along with the improvement of photoelectric technology and semiconductor technology, a flat panel displayer has been widely applied to multiple electronic devices, such as a mobile phone, a notebook computer or a tablet PC (tablet personal computer). Since an active matrix organic light emitting diode displayer has the advantages of wide visual angle, high contrast and high response speed, it is considered as an optimal display panel for replacing a traditional liquid crystal displayer.

An active matrix organic light emitting diode displayer is formed by active matrix organic light emitting diode pixel circuits in a matrix way. The organic light emitting diode pixel circuit mainly includes a capacitor, a driving transistor and an organic light emitting diode. The capacitor is used for storing a signal voltage and providing the signal voltage to the driving transistor. The driving transistor provides a driving current to the organic light emitting diode according to the signal voltage, so that the organic light emitting diode emits light. However, the organic light emitting diode deteriorates gradually resulted from longtime driving and the influence of external environment, so that the offset of the threshold voltage of the light emitting diode is increased, the driving current provided by the driving transistor is attenuated, and thus the light emitting brightness of the organic light emitting diode is attenuated and instable. If the brightness of the organic light emitting diode is instable, the color of the active matrix organic light emitting diode displayer is non-uniform, and the picture quality is further affected.

Therefore, in order to realize a stable and good quality of the active matrix organic light emitting diode displayer, a solution of the above disadvantages is in urgent need.

### SUMMARY

A technical aspect of the present invention provides an active matrix organic light emitting diode pixel circuit. By applying this circuit, attenuation of the light emitting brightness of the organic light emitting diode resulted from the increase of the offset of the threshold voltage of the organic light emitting diode is avoided.

According to an embodiment of the present invention, the active matrix organic light emitting diode pixel circuit includes an organic light emitting diode, a driving circuit, a switching circuit and a capacitor. The organic light emitting diode is connected to a first power source. The driving circuit is connected to the organic light emitting diode. The switching circuit is connected to the driving circuit, the organic light emitting diode and a signal input terminal. The driving circuit is directly connected to a second power source or is electrically connected to the second power source by the switching circuit. The first end and the second end of the capacitor are connected into the switching circuit. In a charge state, with the switching circuit, the first end of the capacitor is electrically connected to the signal input terminal, and the second end of the capacitor is electrically connected to the first power source, or with the switching circuit, the first end of the capacitor is electrically connected to the second power source, and the second end of the capacitor is electrically connected to the signal input terminal. In a compensation state, with the switching circuit, the first end of the capacitor is electrically connected to the signal input terminal, and the second end of the capacitor is electrically connected to an anode of the organic light emitting diode, or with the switching circuit, the first end of the capacitor is electrically connected to the anode of the organic light emitting diode, and the second end of the capacitor is electrically connected to the signal input terminal. In an emission state, with the switching circuit, the first end of the capacitor is electrically connected to the driving circuit, and the second end of the capacitor is electrically connected to the driving circuit and the anode of the organic light emitting diode.

According to another embodiment of the present invention, when the driving circuit is directly connected to the second power source, the driving circuit is a first transistor, the first source/drain electrode of the first transistor is connected to the anode of the organic light emitting diode, and the second source/drain electrode of the first transistor is connected to the second power source.

According to yet another embodiment of the present invention, the switching circuit includes a second transistor, a third transistor, a fourth transistor and a fifth transistor. The first source/drain electrode of the second transistor is connected to the first end of the capacitor, and the second source/drain electrode of the second transistor is connected to the gate electrode of the first transistor. The first source/drain electrode of the third transistor is connected to the first end of the capacitor and the first source/drain electrode of the second transistor, and the second source/drain electrode of the third transistor is connected to the signal input terminal. The first source/drain electrode of the fourth transistor is connected to the second end of the capacitor, and the second source/drain electrode of the fourth transistor is connected to the first source/drain electrode of the first transistor and the anode of the organic light emitting diode. The first source/drain electrode of the fifth transistor is connected to the second end of the capacitor and the first source/drain electrode of the fourth transistor, and the second source/drain electrode of the fifth transistor is connected to the first power source.

According to still yet another embodiment of the present invention, the first to the fifth transistors are all N-type transistors.

According to an embodiment of the present invention, the gate electrode of the second transistor is connected to a first selection wire. The gate electrode of the third transistor is connected to a second selection wire. The gate electrode of the fourth transistor is connected to a third selection wire. The gate electrode of the fifth transistor is connected to a fourth selection wire.

According to another embodiment of the present invention, the first, the third and the fourth transistors are all N-type transistors, and the second and the fifth transistors are P-type transistors.

According to yet another embodiment of the present invention, the gate electrodes of the second transistor and the third transistor are connected to the first selection wire, and gate electrodes of the fourth transistor and the fifth transistor are connected to the second selection wire.

According to still yet another embodiment of the present invention, when the driving circuit is electrically connected to the second power source by the switching circuit, the driving circuit is the first transistor, the first source/drain electrode of the first transistor is connected to the anode of the organic light emitting diode, and the second source/drain electrode of the first transistor is connected to the switching circuit.

According to an embodiment of the present invention, the switching circuit includes a second transistor, a third transistor, a fourth transistor, a fifth transistor, a sixth transistor and a seventh transistor. The first source/drain electrode of the second transistor is connected to the second source/drain electrode of the first transistor, and the second source/drain electrode of the second transistor is connected to the second power source. The first source/drain electrode of the third transistor is connected to the first source/drain electrode of the second transistor and the second source/drain electrode of the first transistor, and the second source/drain electrode of the third transistor is connected to the gate electrode of the first transistor. The first source/drain electrode of the fourth transistor is connected to the second source/drain electrode of the third transistor and the gate electrode of the first transistor, and the second source/drain electrode of the fourth transistor is connected to the first end of the capacitor. The first source/drain electrode of the fifth transistor is connected to the second source/drain electrode of the fourth transistor and the first end of the capacitor, and the second source/drain electrode of the fifth transistor is connected to the anode of the organic light emitting diode and the first source/drain electrode of the first transistor. The first source/drain electrode of the sixth transistor is connected to the second end of the capacitor, and the second source/drain electrode of the sixth transistor is connected to the signal input terminal. The first source/drain electrode of the seventh transistor is connected to the first source/drain electrode of the sixth transistor and the second end of the capacitor, and the second source/drain electrode of the seventh transistor is connected to the second source/drain electrode of the fifth transistor, the anode of the organic light emitting diode and the first source/drain electrode of the first transistor.

According to another embodiment of the present invention, the first to the seventh transistors are all N-type transistors.

According to yet another embodiment of the present invention, the gate electrodes of the second and the fourth transistors are connected to the first selection wire. The gate electrodes of the third and the sixth transistors are connected to the second selection wire. The gate electrode of the fifth transistor is connected to the third selection wire. The gate electrode of the seventh transistor is connected to the fourth selection wire.

According to still yet another embodiment of the present invention, the first, the second, the third, the fourth and the sixth transistors are N-type transistors, and the fifth and the seventh transistors are P-type transistors.

According to an embodiment of the present invention, the gate electrodes of the second, the fourth and the fifth transistors are connected to the first selection wire, and the gate electrodes of the third, the sixth and the seventh transistors are connected to the second selection wire.

Another technical aspect of the present invention provides an operating method of an active matrix organic light emitting diode pixel circuit, so that the light emitting efficiency of the active matrix organic light emitting diode pixel circuit is not attenuated due to the increase of the offset of the threshold voltage of the organic light emitting diode after long-time driving.

According to an embodiment of the present invention, the operating method of the active matrix organic light emitting diode pixel circuit is provided. The active matrix organic light emitting diode pixel circuit includes an organic light emitting diode, a driving circuit a switching circuit and a capacitor. The organic light emitting diode is connected to the first power source. The driving circuit is directly connected to the second power source or is electrically connected to the second power source by the switching circuit. The switching circuit is connected to the signal input terminal. The capacitor is connected into the switching circuit. The operating method of the active matrix organic light emitting diode pixel circuit includes the following steps:

(a) in a charge state, by controlling the switching circuit, a first end of the capacitor is electrically connected to the signal input terminal, and a second end of the capacitor is electrically connected to the first power source; or by controlling the switching circuit, the first end of the capacitor is electrically connected to the second power source, and the second end of the capacitor is electrically connected to the signal input terminal;

(b) in a compensation state, by controlling the switching circuit, the first end of the capacitor is electrically connected to the signal input terminal, and the second end of the capacitor electrically connected to an anode of the organic light emitting diode; or by controlling the switching circuit, the first end of the capacitor is electrically connected to the anode of the organic light emitting diode, and the second end of the capacitor is electrically connected to the signal input terminal; and

(c) in an emission state, by controlling the switching circuit, the first end of the capacitor is electrically connected to the driving circuit, and the second end of the capacitor is electrically connected to the driving circuit and the anode of the organic light emitting diode.

According to another embodiment of the present invention, when the driving circuit is directly connected to the second power source:

the driving circuit is the first transistor, the first source/drain electrode of the first transistor is connected to the anode of the organic light emitting diode, and the second source/drain electrode of the first transistor is connected to the second power source.

The switching circuit includes a second transistor, a third transistor, a fourth transistor and a fifth transistor. The first source/drain electrode of the second transistor is connected to the first end of the capacitor and the first source/drain electrode of the third transistor, and the second source/drain electrode of the second transistor is connected to the gate electrode of the first transistor. The second source/drain electrode of the third transistor is connected to the signal input terminal. The first source/drain electrode of the fourth transistor is connected to the second end of the capacitor and the first source/drain electrode of the fifth transistor. The second source/drain to electrode of the fourth transistor is connected to the first source/drain electrode of the first transistor and the anode of the organic light emitting diode. The second source/drain electrode of the fifth transistor is connected to the first power source.

Furthermore, the step (a) includes: conducting the third and the fifth transistors, and shutting down the second and the fourth transistors, so that the voltage of the first end of the capacitor is the voltage of the signal input terminal, and the voltage of the second end of the capacitor is the voltage of the first power source.

According to yet another embodiment of the present invention, the step (b) includes: conducting the third and the fourth transistors, and shutting down the second and the fifth transistors, so that the capacitor discharges via the organic light emitting diode until no current flows through the organic light emitting diode.

According to still yet another embodiment of the present invention, the step (c) includes: conducting the second and the fourth transistors, and shutting down the third and the fifth transistors, so that the first transistor drives the organic light emitting diode according to potential difference between two ends of the capacitor.

According to an embodiment of the present invention, when the driving circuit is electrically connected to the first power source by the switching circuit:

the driving circuit is the first transistor, and the first source/drain electrode of the first transistor is connected to the anode of the organic light emitting diode.

The switching circuit includes a second transistor, a third transistor, a fourth transistor, a fifth transistor, a sixth transistor and a seventh transistor. The first source/drain electrode of the second transistor is connected to the second source/drain electrode of the first transistor and the first source/drain electrode of the third transistor, and the second source/drain electrode of the second transistor is connected to the second power source. The second source/drain electrode of the third transistor is connected to the gate electrode of the first transistor and the first source/drain electrode of the fourth transistor, and the second source/drain electrode of the fourth transistor is connected to the first end of the capacitor and the first source/drain electrode of the fifth transistor. The second source/drain electrode of the fifth transistor is connected to the anode of the organic light emitting diode, the first source/drain electrode of the first transistor and the second source/drain electrode of the seventh transistor. The first source/drain electrode of the sixth transistor is connected to the second end of the capacitor and the first source/drain electrode of the seventh transistor, and the second source/drain electrode of the sixth transistor is connected to the signal input terminal.

Furthermore, the step (a) includes: conducting the second, the third, the fourth and the sixth transistors, and shutting down the fifth and the seventh transistors, so that the voltage of the first end of the capacitor is the voltage of the second power source, and the voltage of the second end of the capacitor is the voltage of the signal input terminal.

According to another embodiment of the present invention, the step (b) includes: conducting the third, the fifth and the sixth transistors, and shutting down the second, the fourth and the seventh transistors, so that the capacitor discharges via the organic light emitting diode until no current flows through the organic light emitting diode.

According to yet another embodiment of the present invention, the step (c) includes: conducting the second, the fourth and the seventh transistors, and shutting down the third, the fifth and the sixth transistors, so that the first transistor drives the organic light emitting diode according to potential difference between two ends of the capacitor.

In sum, with the application of the circuit architecture and the operating method of the above embodiments, by controlling the switching circuit, the capacitor is connected to the first and the second power sources, the signal input terminal and the anode of the organic light emitting diode respectively in the charge state and the compensation state. In the emission state, the driving circuit is operated by utilizing potential difference between two ends of the capacitor, so that a driving current provided by the driving circuit is increased along with the offset of the threshold voltage of the organic light emitting diode. In this way, the problem that the light emitting brightness of the organic light emitting diode is attenuated due to long-time operation is avoided, the problem that the color of the active matrix organic light emitting diode displayer is non-uniform due to attenuation of light emitting brightness is solved, and the quality of the active matrix organic light emitting diode displayer is effectively improved.

### BRIEF DESCRIPTION OF THE DRAWINGS

In order to make the foregoing as well as other aspects, features, advantages, and embodiments of the present invention more apparent, the accompanying drawings are described as follows:

FIG. 1 illustrates a circuit diagram drawn according to an active matrix organic light emitting diode pixel circuit in the first embodiment of the present invention;

FIG. 2 illustrates a sequence diagram of selection wires of the first embodiment of the present invention;

FIG. 3 illustrates an equivalent circuit drawn according to the active matrix organic light emitting diode pixel circuit of FIG. 1 in a charge state;

FIG. 4 illustrates an equivalent circuit drawn according to the active matrix organic light emitting diode pixel circuit of FIG. 1 in a compensation state;

FIG. 5 illustrates an equivalent circuit drawn according to the active matrix organic light emitting diode pixel circuit of FIG. 1 or FIG. 8 in an emission state;

FIG. 6 illustrates a circuit diagram drawn according to an active matrix organic light emitting diode pixel circuit in the second embodiment of the present invention;

FIG. 7 illustrates a sequence diagram of selection wires of the second embodiment of the present invention;

FIG. 8 illustrates a circuit diagram drawn according to an active matrix organic light emitting diode pixel circuit in the third embodiment of the present invention;

FIG. 9 illustrates a sequence diagram of selection wires of the third embodiment of the present invention;

FIG. 10 illustrates an equivalent circuit drawn according to the active matrix organic light emitting diode pixel circuit of FIG. 8 in a charge state:

FIG. 11 illustrates an equivalent circuit drawn according to the active matrix organic light emitting diode pixel circuit of FIG. 8 in a compensation state;

FIG. 12 illustrates a circuit diagram drawn according to an active matrix organic light emitting diode pixel circuit in the fourth embodiment of the present invention; and

FIG. 13 illustrates a sequence diagram of selection wires of the fourth embodiment of the present invention.

### DETAILED DESCRIPTION

The spirit of the present invention will be described with reference to the accompanying drawings and the following detailed description. It will be apparent to those skilled in the art that various modifications and variations can be made to the technology taught in the present invention without departing from the scope and the spirit of the present invention.

If it is not specially indicated, the phrase “connection” used in the context refers to direct connection or indirect connection. That is, one end is connected to another end via a medium or not. Correspondingly, the phrase “direct connection” used in the context means that one end is connected to another end without a medium. In addition, the phrase “electric connection” used in the context means that an electric signal can be transferred between one end and another end.

The phrases “a first source/drain electrode” and “a second source/drain electrode” used in the context refer to a source electrode or a drain electrode of a transistor. When “the first source/drain electrode” is the source electrode, the “second source/drain electrode” is the drain electrode. When “the first source/drain electrode” is the drain electrode, the “second source/drain electrode” is the source electrode.

The offset of the threshold voltage of a traditional active matrix organic light emitting diode pixel circuit is increased after the light emitting diode is used for a long time, so that the driving current is reduced, and thus the light emitting brightness of the organic light emitting diode is attenuated, and the picture quality of the active matrix organic light emitting diode is decreased. Therefore, if the potential difference between two ends of the capacitor is increased along with the increase of the offset of the threshold voltage of the organic light emitting diode by controlling the switching circuit of the active matrix organic light emitting diode pixel circuit, the driving circuit can be controlled by utilizing the capacitor, so that the driving circuit generates a driving current corresponding to the threshold voltage. When the offset of the threshold voltage of the organic light emitting diode is increased after long-time use, the driving current is increased correspondingly, so as to keep the light emitting brightness of the organic light emitting diode.

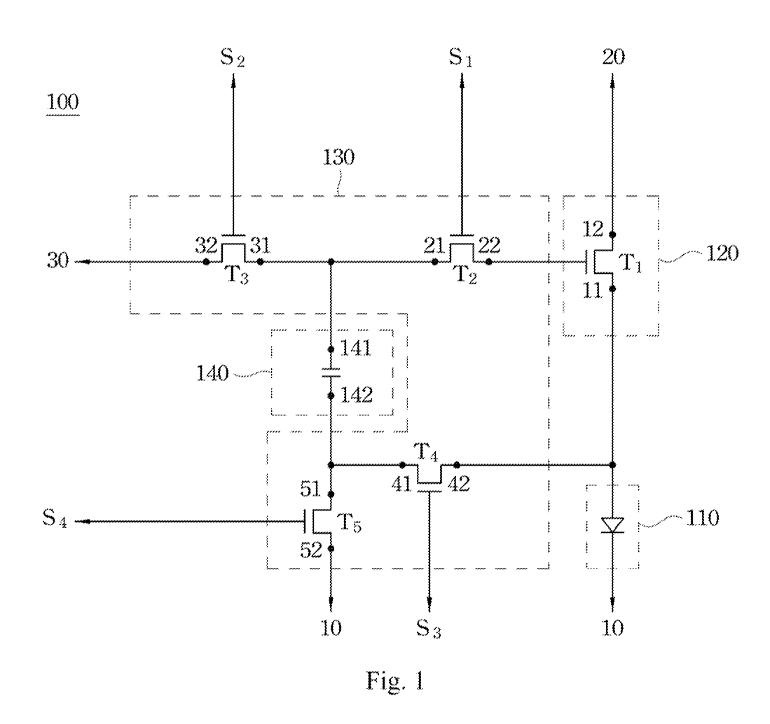

FIG. 1 illustrates a circuit diagram drawn according to an active matrix organic light emitting diode pixel circuit 100 in the first embodiment of the present invention. The active matrix organic light emitting diode pixel circuit 100 includes an organic light emitting diode 110, a driving circuit 120, a switching circuit 130 and a capacitor 140. The organic light emitting diode 110 is connected to a first power source 10. The driving circuit 120 is connected to the organic light emitting diode 110 and is directly connected to a second power source 20. The switching circuit 130 is connected to the driving circuit 120, the organic light emitting diode 110, the first power source and a signal input terminal 30. A first end 141 and a second end 142 of the capacitor 140 are connected into the switching circuit 130. Here, the voltage V_{dd} of the second power source 20 is higher than the voltage Vₛₛ of the first power source 10.

In a first embodiment, the driving circuit 120 may be a first transistor T1. The first source/drain electrode 11 of the first transistor T1 is connected to the anode of the organic light emitting diode 110, and the second source/drain electrode 12 of the first transistor T1 is directly connected to the second power source 20. The switching circuit 130 includes a second transistor T2, a third transistor T3, a fourth transistor T4 and a fifth transistor T5. The first source/drain electrode 21 of the second transistor T2 is connected to the first end 141 of the capacitor 140, and the second source/drain electrode 22 of the second transistor T2 is connected to the gate electrode of the first transistor T1. The first source/drain electrode 31 of the third transistor T3 is connected to the first end 141 of the capacitor 140 and the first source/drain electrode 21 of the second transistor T2, and the second source/drain electrode 32 of the third transistor T3 is connected to the signal input terminal 30. The first source/drain electrode 41 of the fourth transistor T4 is connected to the second end 142 of the capacitor 140, and the second source/drain electrode 42 of the fourth transistor T4 is connected to the first source/drain electrode 11 of the first transistor T1 and the anode of the organic light emitting diode 110. The first source/drain electrode 51 of the fifth transistor T5 is connected to the second end 142 of the capacitor 140 and the first source/drain electrode 41 of the fourth transistor T4, and the second source/drain electrode 52 of the fifth transistor T5 is connected to the first power source 10.

The above first to fifth transistors. T1, T2, T3, T4 and T5, are all N-type transistor. The gate electrode of the second transistor T2 is connected to a first selection wire S1, the gate electrode of the third transistor T3 is connected to a second selection wire S2 the gate electrode of the fourth transistor T4 is connected to a third selection wire S3, and the gate electrode of the fifth transistor T5 is connected to a fourth selection wire S4.

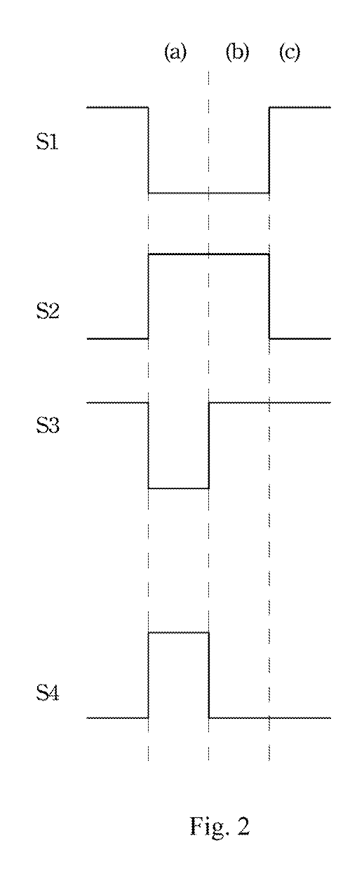

FIG. 2 illustrates a sequence diagram of the first to the fourth selection wires, S1 S2, S3 and S4, of the first embodiment of the present invention. According to FIG. 2, the operating method of the active matrix organic light emitting diode pixel circuit 100 includes:

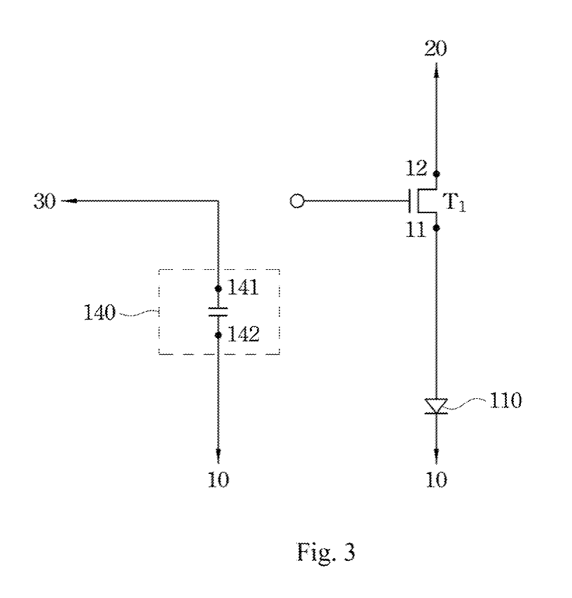

in a charge state (a), controlling the second and the fourth selection wires S2 and S4 to have a high voltage level so as to conduct the third and the fifth transistors T3 and T5, and controlling the first and the third selection wires S1 and S3 to have a low voltage level so as to shut down the second and the fourth transistors T2 and T4; electrically connecting the first end 141 of the capacitor 140 to the signal input terminal 30, and electrically connecting the second end 142 of the capacitor 140 to the first power source 10, wherein the equivalent circuit is shown in FIG. 3; at this time, the capacitor 140 is charged by the signal input terminal 30, so that the voltage V_{c1} of the first end 141 of the capacitor 140 is the voltage V_{data} of the signal input terminal 30, and the voltage V_{c2} of the second end 142 of the capacitor 140 is the voltage Vₛₛ, of the first power source 10. That is:

V_{c1}=V_{data}

V_{c2}=Vₛₛ;

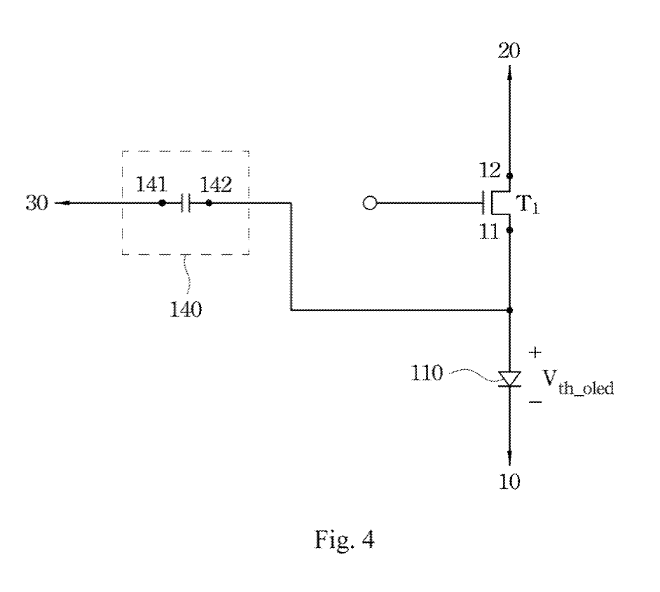

in a compensation state (b), controlling the second and the third selection wires S2 and S3 to have a high voltage level so as to conduct the third and the fourth transistors 13 and 14, and controlling the first and the fourth selection wires S1 and S4 to have a low voltage level so as to shut down the second and to the fifth transistors T2 and T5; electrically connecting the first end 141 of the capacitor 140 to the signal input terminal 30, and electrically connecting the second end 142 of the capacitor 140 to the first power source 10, wherein the equivalent circuit is shown in FIG. 4; at this time, the capacitor 140 discharges via the organic light emitting diode 110 until no current flows through the organic light emitting diode 110, so that the voltage Vₐ of the second end 142 of the capacitor 140 is the sum of the threshold voltage Vₜₕ_{_{—}}_{oled} the organic light emitting diode 110 and the voltage Vₛₛ, of the first power source 10, and the voltage V_{c1} of the first end 141 of the capacitor 140 is kept to be the voltage V_{data} of the signal input terminal 30. That is:

V_{c1}=V_{data}

V_{c2}=Vₜₕ_{_{—}}_{oled}+Vₛₛ;

and the potential difference between two ends of the capacitor 140 is: V_{c1}−V_{c2}=V_{data}−Vₜₕ_{_{—}}_{oled}−Vₛₛ; and

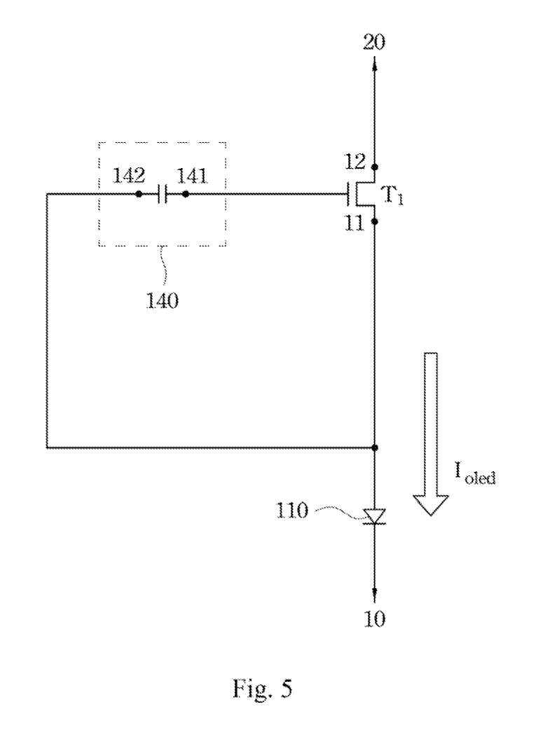

in an emission state (c), controlling the first and the third selection wires S1 and S3 to have a high voltage level so as to conduct the second and the fourth transistors T2 and T4, and controlling the second and the fourth selection wires S2 and S4 to have a low voltage level so as to shut down the third and the fifth transistors T3 and T5; electrically connecting the first end 141 of the capacitor 140 to the gate electrode of the first transistor 11, and electrically connecting the second end 142 of the capacitor 140 to the first source/drain electrode 11 of the first transistor T1 and the anode of the organic light emitting diode 110, wherein the equivalent circuit is shown in FIG. 5; at this time, the first transistor T1 generates a driving circuit I_{oled} according to the potential difference between two ends of the capacitor 140, so as to drive the organic light emitting diode 110. The driving circuit I_{oled} is calculated according to the following formula:

I_{oled}=K(V_{gs}−Vₜₕ_{_{—}}_{TFT})̂2),

Wherein, V_{gs} is the potential difference between two ends of the capacitor 140. That is:

V_{gs}=V_{c1}−V_{c2}=V_{data}−Vₜₕ_{_{—}}_{oled}V−ₛₛ;

and therefore, it can be further educed that:

I_{oled}=K(V_{data}−Vₜₕ_{_{—}}_{oled}−Vₛₛ−Vₜₕ_{_{—}}_{TFT})̂2.

In the above formula, K is a constant, and Vₜₕ_{_{—}}_{TFT} is the threshold voltage of the first transistor T1. It can be known that via the operation of the switching circuit 130, the driving current I_{oled} is increased along with the increase of the offset of the threshold voltage Vₜₕ_{_{—}}_{oled} of the organic light emitting diode 110. Therefore, attenuation of the light emitting brightness of the organic light emitting diode 110 resulted from long-time driving is compensated therefrom.

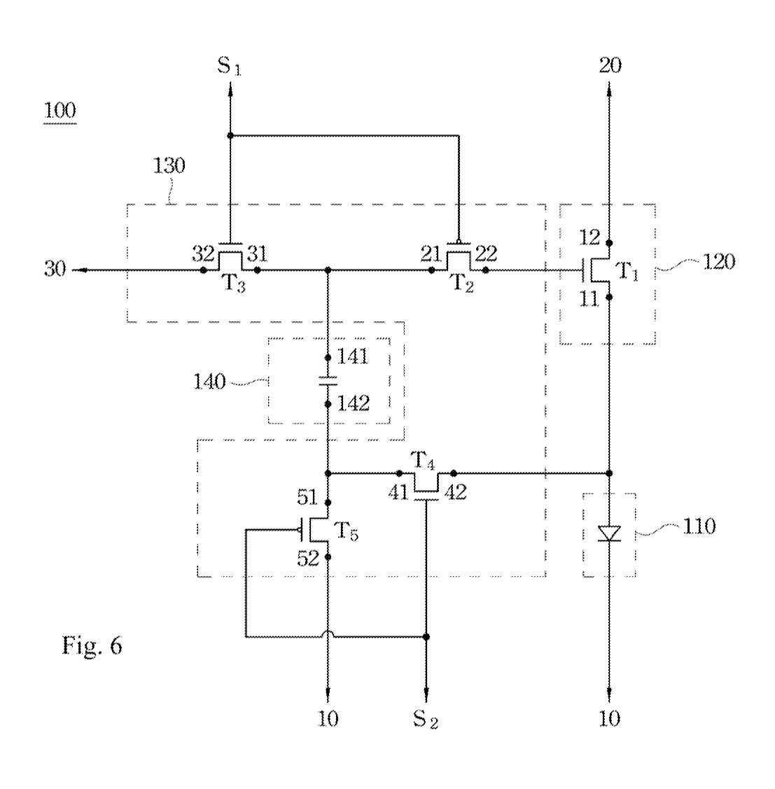

FIG. 6 illustrates a circuit diagram drawn according to an active matrix organic light emitting diode pixel circuit 100 in the second embodiment of the present invention. In the second embodiment, the architecture of the active matrix organic light emitting diode pixel circuit 100 is similar to that of the first embodiment, and thus unnecessary details are not given to the common parts. What is different is that, in the second embodiment, the first, the third and the fourth transistors are all N-type transistors, and the second and the fifth transistors are P-type transistors, wherein the gate electrodes of the second and the third transistors T2 and T3 are connected to the first selection wire S1, and the gate electrodes of the fourth and the fifth transistors T4 and T5 are connected to the second selection wire S2.

Via the above replacement, compared with the first embodiment, two selection wires are reduced in the second embodiment, so as to reduce the complexity of the system, thereby facilitating the realization of the embodiment of the present invention.

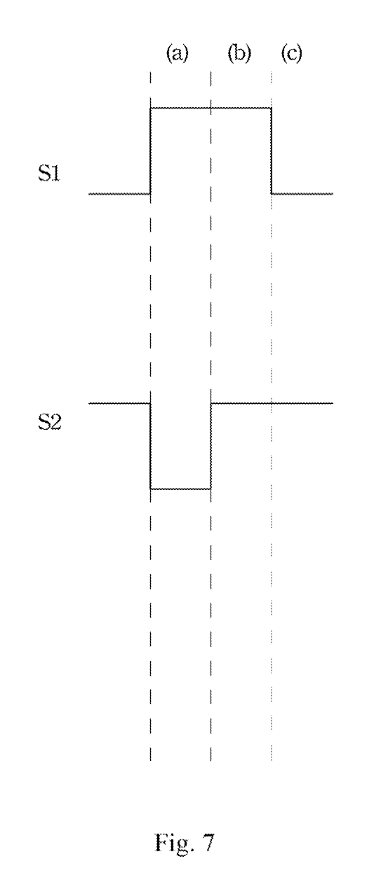

FIG. 7 illustrates a sequence diagram of the first and the second selection wires S1 and S2 of the second embodiment of the present invention. According to FIG. 7, the operating method of the active matrix organic light emitting diode pixel circuit 100 includes:

In a charge state (a), controlling the first selection wire S1 to have a high voltage level so as to conduct the third transistor T3 and shut down the second transistor T2, and controlling the second selection wire S2 to have a low voltage level so as to shut down the fourth transistor T4 and conduct the fifth transistor T5; electrically connecting the first end 141 of the capacitor 140 to the signal input terminal 30, and electrically connecting the second end 142 of the capacitor to the first power source 10, wherein the equivalent circuit shown in FIG. 3; at this time, the charge manner of the capacitor 140 is identical to that of the first embodiment, and thus unnecessary details are not given here;

in a compensation state (b), controlling the first selection wire S1 to have a high voltage level so as to conduct the third transistor T3 and shut down the second transistor T2, and controlling the second selection wire S2 to have a high voltage level so as to shut down the fifth transistor T5 and conduct the fourth transistor T4; electrically connecting the first end 141 of the capacitor 140 to the signal input terminal 30, and electrically connecting the second end 142 of the capacitor 140 to the first power source 10, wherein the equivalent circuit is shown in FIG. 4; at this time, the discharge manner of the capacitor 140 via the organic light emitting diode 110 is identical to that of the first embodiment, and thus unnecessary details are not given here; and

in an emission state (c), controlling the second selection wire S2 to have a high voltage level so as to shut down the fifth transistor T5 and conduct the fourth transistor T4, and controlling the first selection wire S1 to have a low voltage level so as to shut down the third transistor T3 and conduct the second transistor T2; electrically connecting the first end 141 of the capacitor 140 to the gate electrode of the first transistor T1, and electrically connecting the second end 142 of the capacitor 140 to the first source/drain electrode 11 of the first transistor T1 and the anode of the organic light emitting diode 110, wherein the equivalent circuit is shown in FIG. 5; at this time, the manner that the first transistor T1 drives the organic light emitting diode 110 according to the potential difference between two ends of the capacitor 140 is identical to that of the first embodiment, and thus unnecessary details are not given here.

With descriptions of the above first and second embodiments, pixel circuits of five transistors and the operating method thereof are provided, so that the attenuation of the light emitting brightness of the organic light emitting diode 110 resulted from long-time driving is compensated. In order to describe the embodiments of the present invention more completely, embodiments of the pixel circuits of seven transistors and the operating method thereof are provided in the following context.

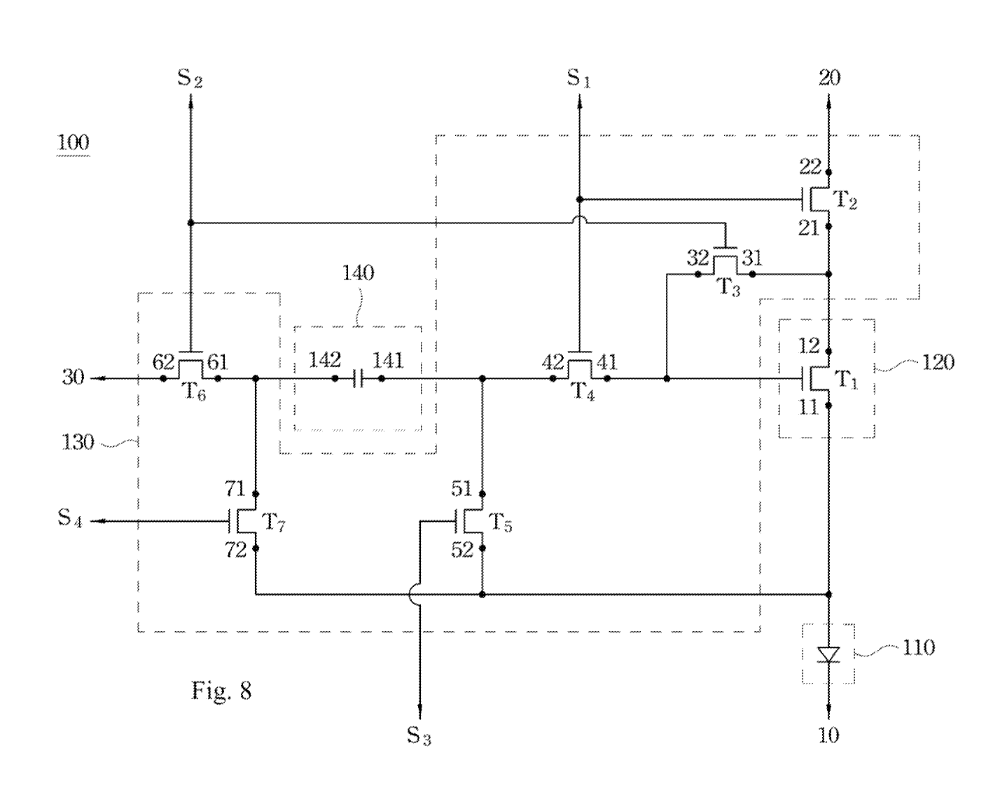

FIG. 8 illustrates a circuit diagram drawn according to an active matrix organic light emitting diode pixel circuit 100 in the third embodiment of the present invention. In the third embodiment, the active matrix organic light emitting diode pixel circuit 100 includes an organic light emitting diode 110, a driving circuit 120, a switching circuit 130 and a capacitor 140. The organic light emitting diode 110 is connected to the first power source 10. The driving circuit 120 is connected to the organic light emitting diode 110 and is connected to the second power source 20 by the switching circuit 130. The switching circuit 130 is connected to the driving circuit 120, the organic light emitting diode 110, the second power source 20 and the signal input terminal 30. The first end 141 and the second end 142 of the capacitor 140 are connected into the switching circuit 130. Here, the voltage V_{dd} of the second power source 20 is higher than the voltage Vₛₛ of the first power source 10.

In the third embodiment, the driving circuit 120 is the first transistor T1. The first source/drain electrode 11 of the first transistor 11 is connected to the anode of the organic light emitting diode 110, and the second source/drain electrode 12 of the first transistor T1 is connected to the switching circuit 130. The switching circuit 130 includes a second transistor T2, a third transistor T3, a fourth transistor T4, a fifth transistor T5, a sixth transistor T6 and a seventh transistor T7. The first source/drain electrode 21 of the second transistor T2 is connected to the second source/drain electrode 12 of the first transistor T1, and the second source/drain electrode 22 of the second transistor T2 is connected to the second power source 20. The first source/drain electrode 31 of the third transistor T3 is connected to the first source/drain electrode 21 of the second transistor T2 and the second source/drain electrode 12 of the first transistor T1, and the second source/drain electrode 32 of the third transistor T3 is connected to the gate electrode of the first transistor T1. The first source/drain electrode 41 of the fourth transistor T4 is connected to the second source/drain electrode 32 of the third transistor T3 and the gate electrode of the first transistor T1, and the second source/drain electrode 42 of the fourth transistor T4 is connected to the first end 141 of the capacitor 140. The first source/drain electrode 51 of the fifth transistor T5 is connected to the second source/drain electrode 42 of the fourth transistor T4 and the first end 141 of the capacitor 140, and the second source/drain electrode 52 of the fifth transistor T5 is connected to the anode of the organic light emitting diode 110 and the first source/drain electrode 11 of the first transistor T1. The first source/drain electrode 61 of the sixth transistor T6 is connected to the second end 142 of the capacitor 140, and the second source/drain electrode 62 of the sixth transistor T6 is connected to the signal input terminal 30. The first source/drain electrode 71 of the seventh transistor T7 is connected to the first source/drain electrode 61 of the sixth transistor T6 and the second end 142 of the capacitor 140, and the second source/drain electrode 72 of the seventh transistor T7 is connected to the second source/drain electrode 52 of the fifth transistor T5, the anode of the organic light emitting diode 110 and the first source/drain electrode 11 of the first transistor T1.

The above first to seventh transistors, T1, T2, T3, T4, T5, T6 and T7, are all N-type transistors. The gate electrodes of the second and the fourth transistors T2 and T4 are connected to the first selection wire S1. The gate electrodes of the third and the sixth transistors T3 and T6 are connected to the second selection wire 32. The gate electrode of the fifth transistor T5 is connected to the third selection wire S3. The gate electrode of the seventh transistor T7 is connected to the fourth selection wire S4.

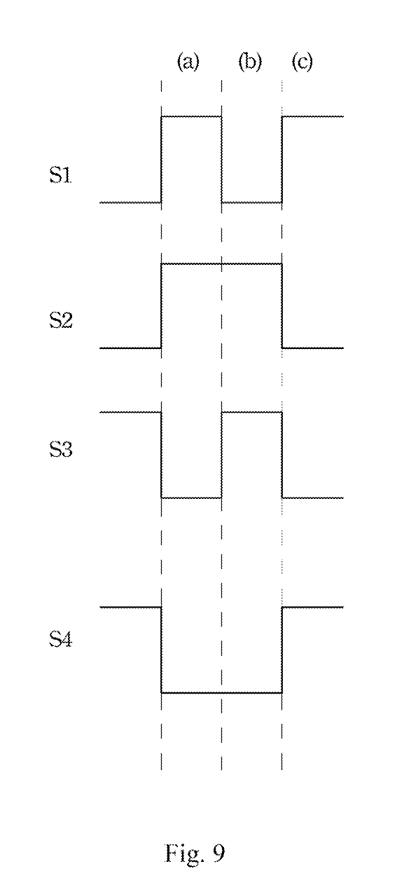

FIG. 9 illustrates a sequence diagram of the first to the fourth selection wires. S1, S2, S3 and S4, of the third embodiment of the present invention. According to FIG. 9, the operating method of the active matrix organic light emitting diode pixel circuit 100 includes:

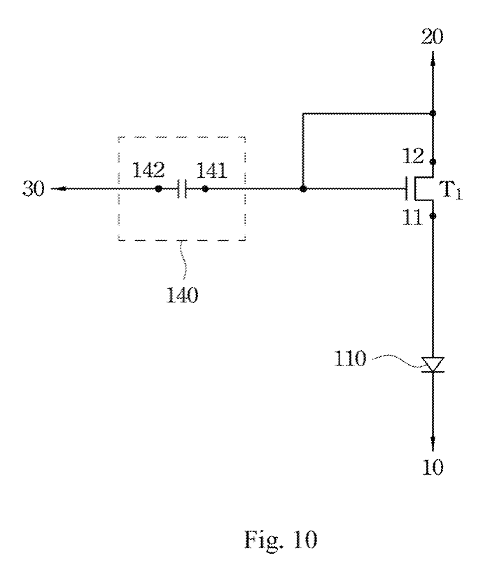

in a charge state (a), controlling the first and the second selection wires S1 and S2 to have a high voltage level so as to conduct the second, the third, the fourth and the sixth transistors T2, T3, T4 and T6, and controlling the third and the fourth selection wires S3 and S4 to have a low voltage level so as to shut down the fifth and the seventh transistors T5 and T7; electrically connecting the first end 141 of the capacitor 140 to the second power source 20, and electrically connecting the second end 142 of the capacitor 140 to the signal input terminal 30, wherein the equivalent circuit is shown in FIG. 10; at this time, the capacitor 140 is charged, the voltage V_{c1} of the first end 141 of the capacitor 140 is the voltage V_{dd} of the second power source 20, and the voltage V_{c2} of the second end 142 of the capacitor 140 is the voltage V_{data} of the signal input terminal 30. That is:

V_{c1}=V_{dd}

V_{c2}=V_{data}.

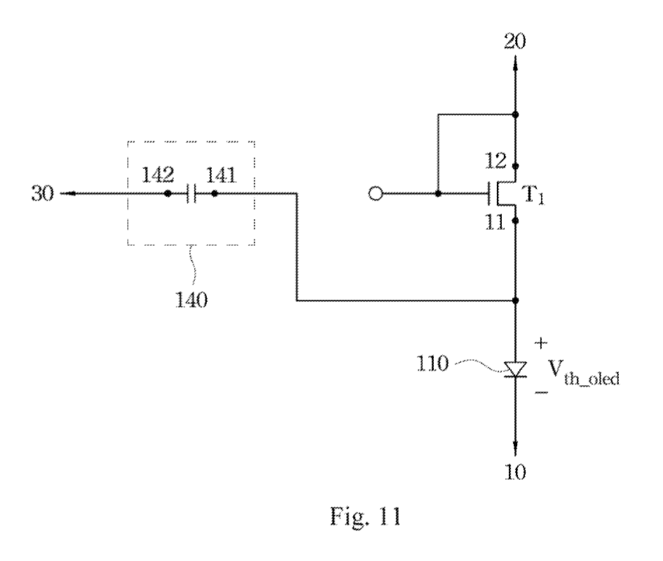

in a compensation state (b), controlling the second and the third selection wires S2 and S3 to have a high voltage level so as to conduct the third, the fifth and the sixth transistors T3, T5 and T6, and controlling the first and the fourth selection wires S1 and S4 to have a low voltage level so as to shut down the second, the fourth and the seventh transistors T2, T4 and T7; electrically connecting the first end 141 of the capacitor 140 to the anode of the organic light emitting diode 110, and keeping the second end 142 of the capacitor 140 to be electrically connected to the signal input terminal 30, wherein the equivalent circuit is shown in FIG. 11; at this time, the capacitor 140 discharges via the organic light emitting diode 110 until no current flow through the organic light emitting diode 110, so that the voltage V_{c1} of the first end 141 of the capacitor 140 is the sum of the threshold voltage Vₜₕ_{_{—}}_{oled} of the organic light emitting diode 110 and the voltage Vₛₛ of the first power source, and the voltage V_{c2} of the second end 142 of the capacitor 140 is kept to be the voltage V_{data} of the signal input terminal 30. That is:

V_{c1}=Vₜₕ_{_{—}}_{oled}+Vₛₛ

V_{c2}=V_{data}

and the potential difference between two ends of the capacitor 140 is: V_{c1}−V_{c2}=Vₜₕ_{_{—}}_{oled} Vₛₛ˜V_{data}; and

in an emission state (c), controlling the first and the fourth selection wires S1 and S4 to have a high voltage level so as to conduct the second, the fourth and the seventh transistors T2, T4 and T7, and controlling the second and the third selection wires S2 and S3 to have a low voltage level so as to shut down the third, the fifth and the sixth transistors T3, T5 and T6; electrically connecting the first end 141 of the capacitor 140 to the gate electrode of the first transistor T1, and electrically connecting the second end 142 of the capacitor 140 to the first source/drain electrode 11 of the first transistor and the anode of the organic light emitting diode 110, wherein the equivalent circuit is shown in FIG. 5; at this time, the first transistor T1 generates a driving current I_{oled} according to the potential difference between two ends of the capacitor 140, so as to drive the organic light emitting diode 110. The driving current I_{oled} is calculated according to the following formula:

I_{oled}=K(V_{gs}−Vₜₕ_{_{—}}_{TFT})̂2,

wherein, V_{g}, is the potential difference between two ends of the capacitor 140. That is:

V_{gs}=V_{c1}−V_{c2}=Vₜₕ_{_{—}}_{oled}+Vₛₛ−V_{data};

and therefore, it can be further educed that:

I_{oled}=K(Vₜₕ_{_{—}}_{oled}−Vₛₛ−V_{data}−Vₜₕ_{_{—}}_{TFT})̂2.

In the above formula, K is a constant, and Vₜₕ_{_{—}}_{TFT} is the threshold voltage of the first transistor T1. It can be known that via the operation of the switching circuit 130, the driving current I_{oled} s increased along with the increase of the offset of the threshold voltage Vₜₕ_{_{—}}_{oled} of the organic light emitting diode 110. Therefore, attenuation of the light emitting brightness of the organic light emitting diode 110 resulted from long-time driving is compensated therefrom.

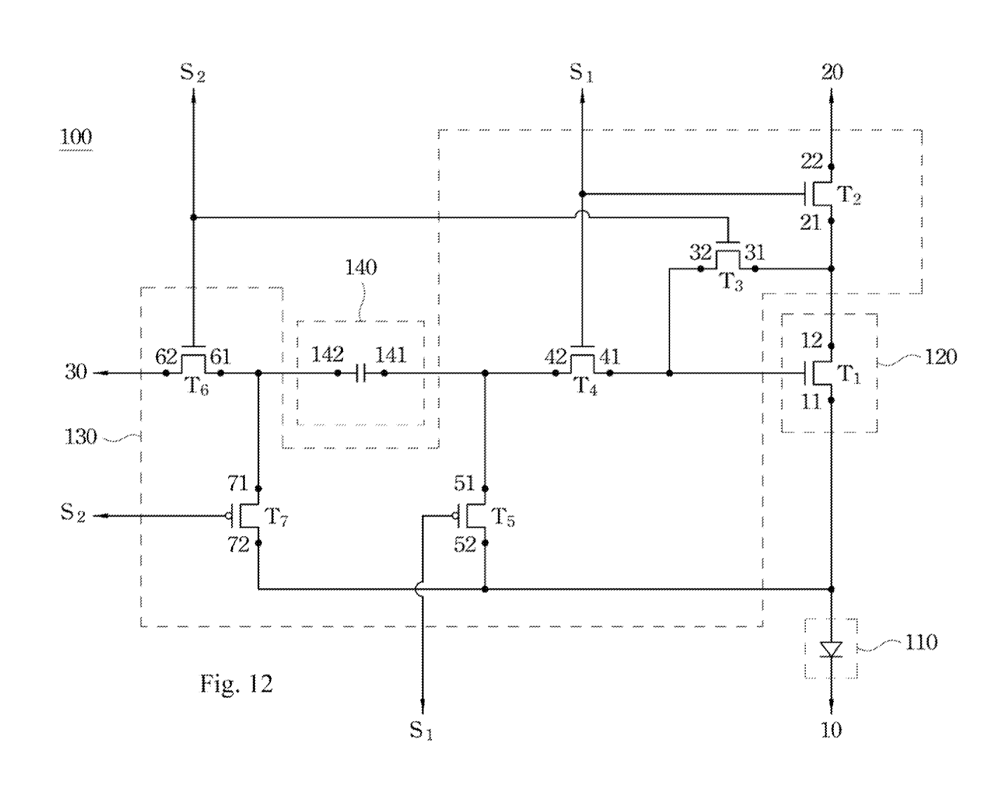

FIG. 12 illustrates a circuit diagram drawn according to an active matrix organic light emitting diode pixel circuit 100 in the fourth embodiment of the present invention. In the fourth embodiment, the architecture of the active matrix organic light emitting diode pixel circuit 100 is similar to that of the third embodiment, and thus unnecessary details are not given to the common parts. What is different is that, in the fourth embodiment, the first, the second, the third, the fourth and the sixth transistors are N-type transistors, and the fifth and the seventh transistors are P-type transistors, wherein the gate electrodes of the second, the fourth and the fifth transistors T2, T4 and T5 are connected to the first selection wire S1, and the gate electrodes of the third, the sixth and the seventh transistors T3, T6 and T7 are connected to the second selection wire S2

Via the above replacement, compared with the third embodiment, two selection wires are reduced in the fourth embodiment, so as to reduce the complexity of the system, thereby facilitating the realization of the embodiment of the present invention.

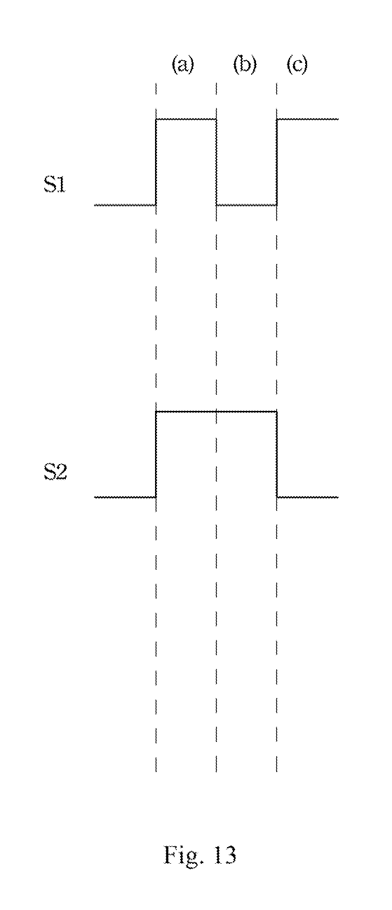

FIG. 13 illustrates a sequence diagram of selection wires S1 and S2 of the fourth embodiment of the present invention. According to FIG. 13, the operating method of the active matrix organic light emitting diode pixel circuit 100 includes:

in a charge state (a), controlling the first and the second selection wires S1 and S2 to have a high voltage level so as to conduct the second, the third, the fourth and the sixth transistors T2, T3, T4 and T6; electrically connecting the first end 141 of the capacitor 140 to the second power source 20 and electrically connecting the second end 142 of the capacitor 140 to the signal input terminal 30, wherein the equivalent circuit is shown in FIG. 10; at this time, the charge manner of the capacitor 140 is identical to that of the third embodiment, and thus unnecessary details are not given here;

in a compensation state (b), controlling the second selection wire S2 to have a high voltage level so as to conduct the third and the sixth transistors T3 and T6 and shut down the seventh transistor T7, and controlling the first selection wire S1 to have a low voltage level so as to shut down the second and the fourth transistors T2 and T4 and conduct the fifth transistor T5; electrically connecting the first end 141 of the capacitor 140 to the anode of the organic light emitting diode 110, and keeping the second end 142 of the capacitor 140 to be electrically connected to the signal input terminal 30, wherein the equivalent circuit is shown in FIG. 11; at this time, the discharge manner of the capacitor 140 via the organic light emitting diode 110 is identical to that of the third embodiment, and thus unnecessary details are not given here;

in an emission state (c), controlling the first selection wire S1 to have a high voltage level so as to conduct the second and the fourth transistors T2 and T4 and shut down the fifth transistor T5, and controlling the second selection wire S2 to have a low voltage level so as to shut down the third and the sixth transistors T3 and T6 and conduct the seventh transistor T7; electrically connecting the first end 141 of the capacitor 140 to the gate electrode of the first transistor T1, and electrically connecting the second end 142 of the capacitor 140 to the first source/drain electrode 11 of the first transistor T1 and the anode of the organic light emitting diode 110, wherein the equivalent circuit is shown in FIG. 5; at this time, the manner that the first transistor T1 drives the organic light emitting diode 110 according to potential difference between two ends of the capacitor 140 is identical to that of the third embodiment, and thus unnecessary details are not given here.

In conclusion, the embodiment of the present invention provides an active matrix organic light emitting diode pixel circuit which includes an organic light emitting diode, a driving circuit, a switching circuit and a capacitor. The organic light emitting diode is connected to a first power source. The driving circuit is connected to the organic light emitting diode. The switching circuit is connected to the driving circuit, the organic light emitting diode and the signal input terminal, wherein the driving circuit is directly connected to the second power source or is electrically connected to the second power source by the switching circuit. A first end and a second end of the capacitor are connected into the switching circuit.

In another aspect, the operating method of the active matrix organic light emitting diode pixel circuit includes:

(a) in a charge state, by controlling the switching circuit, a first end of the capacitor electrically connected to a signal input terminal, and a second end of the capacitor is electrically connected to a first power source; or by controlling the switching circuit, a first end of the capacitor is electrically connected to a second power source, and a second end of the capacitor is electrically connected to the signal input terminal;

(b) in a compensation state, by controlling the switching circuit, the first end of the capacitor is electrically connected to the signal input terminal, and the second end of the capacitor is electrically connected to an anode of the organic light emitting diode; or by controlling the switching circuit, the first end of the capacitor is electrically connected to the anode of the organic light emitting diode, and the second end of the capacitor is electrically connected to the signal input terminal; and

(c) in an emission state, by controlling the switching circuit, the first end of the capacitor is electrically connected to the driving circuit, and the second end of the capacitor is electrically connected to the driving circuit and the anode of the organic light emitting diode.

With the above pixel circuit and operating method, attenuation of the light emitting brightness of the organic light emitting diode pixel circuit after long-time driving can be compensated, so as to guarantee the stability of the active matrix organic light emitting diode displayer, and further improve the quality of the active matrix organic light emitting diode displayer.

Although the present invention has been disclosed with reference to the above embodiments, these embodiments are not intended to limit the present invention. It will be apparent to those skilled in the art that various modifications and variations can be made without departing from the scope or spirit of the present invention. Therefore, the scope of the present invention shall be defined by the appended claims.

What is claimed is:

1. An active matrix organic light emitting diode pixel circuit, comprising:
an organic light emitting diode connected to a first power source;
a driving circuit connected to the organic light emitting diode;
a switching circuit connected to the driving circuit, the organic light emitting diode and a signal input terminal, wherein the driving circuit is directly connected to a second power source or is electrically connected to the second power source by the switching circuit; and
a capacitor, wherein a first end and a second end of the capacitor are connected to internal of the switching circuit;
wherein the first end of the capacitor is electrically connected to the signal input terminal through the switching circuit in a charge state, and the second end of the capacitor is electrically connected to the first power source; or the first end of the capacitor is electrically connected to the second power source through the switching circuit, and the second end of the capacitor is electrically connected to the signal input terminal;
wherein the first end of the capacitor is electrically connected to the signal input terminal through the switching circuit in a compensation state, and the second end of the capacitor is electrically connected to an anode of the organic light emitting diode; or the first end of the capacitor is electrically connected to the anode of the organic light emitting diode through the switching circuit, and the second end of the capacitor is electrically connected to the signal input terminal; and
wherein in an emission state, with the switching circuit, the first end of the capacitor is electrically connected to the driving circuit, and the second end of the capacitor is electrically connected to the driving circuit and the anode of the organic light emitting diode.

2. The active matrix organic light emitting diode pixel circuit of claim 1, wherein when the driving circuit is directly connected to the second power source, the driving circuit is a first transistor, and a first source/drain electrode of the first transistor is connected to the anode of the organic light emitting diode, and a second source/drain electrode of the first transistor is connected to the second power source.

3. The active matrix organic light emitting diode pixel circuit of claim 2, wherein the switching circuit comprises:
a second transistor, wherein a first source/drain electrode of the second transistor is connected to the first end of the capacitor, and a second source/drain electrode of the second transistor is connected to a gate electrode of the first transistor;
a third transistor, wherein a first source/drain electrode of the third transistor is connected to the first end of the capacitor and the first source/drain electrode of the second transistor, and a second source/drain electrode of the third transistor is connected to the signal input terminal,
a fourth transistor, wherein a first source/drain electrode of the fourth transistor is connected to the second end of the capacitor, and a second source/drain electrode of the fourth transistor is connected to the first source/drain electrode of the first transistor and the anode of the organic light emitting diode; and
a fifth transistor, wherein a first source/drain electrode of the fifth transistor is connected to the second end of the capacitor and the first source/drain electrode of the fourth transistor, and a second source/drain electrode of the fifth transistor is connected to the first power source.

4. The active matrix organic light emitting diode pixel circuit of claim 3, wherein the first to the fifth transistors are N-type transistors.

5. The active matrix organic light emitting diode pixel circuit of claim 4, wherein:
a gate electrode of the second transistor is connected to a first selection wire:
a gate electrode of the third transistor is connected to a second selection wire;
a gate electrode of the fourth transistor is connected to a third selection wire; and
a gate electrode of the fifth transistor is connected to a fourth selection wire.

6. The active matrix organic light emitting diode pixel circuit of claim 3, wherein the first, the third and the fourth transistors are N-type transistors, and the second and the fifth transistors are P-type transistors.

7. The active matrix organic light emitting diode pixel circuit of claim 6, wherein:
the gate electrodes of the second and the third transistors are connected to a first selection wire; and
the gate electrodes of the fourth and the fifth transistors are connected to a second selection wire.

8. The active matrix organic light emitting diode pixel circuit of claim 1, wherein when the driving circuit is electrically connected to the second power source by the switching circuit, the driving circuit is a first transistor, a first source/drain electrode of the first transistor is connected to the anode of the organic light emitting diode, and a second source/drain electrode of the first transistor is connected to the switching circuit.

9. The active matrix organic light emitting diode pixel circuit of claim 8, wherein the switching circuit comprises:
a second transistor, wherein a first source/drain electrode of the second transistor is connected to the second source/drain electrode of the first transistor, and a second source/drain electrode of the second transistor is connected to the second power source;
a third transistor, wherein a first source/drain electrode of the third transistor is connected to the first source/drain electrode of the second transistor and the second source/drain electrode of the first transistor, and a second source/drain electrode of the third transistor is connected to a gate electrode of the first transistor;
a fourth transistor, wherein a first source/drain electrode of the fourth transistor is connected to the second source/drain electrode of the third transistor and the gate electrode of the first transistor, and a second source/drain electrode of the fourth transistor is connected to the first end of the capacitor;
a fifth transistor, wherein a first source/drain electrode of the fifth transistor is connected to the second source/drain electrode of the fourth transistor and the first end of the capacitor, and a second source/drain electrode of the fifth transistor is connected to the anode of the organic light emitting diode and the first source/drain electrode of the first transistor;
a sixth transistor, wherein a first source/drain electrode of the sixth transistor is connected to the second end of the capacitor, and a second source/drain electrode of the sixth transistor is connected to the signal input terminal; and
a seventh transistor, wherein a first source/drain electrode of the seventh transistor is connected to the first source/drain electrode of the sixth transistor and the second end of the capacitor, and a second source/drain electrode of the seventh transistor is connected to the second source/drain electrode of the fifth transistor, the anode of the organic light emitting diode and the first source/drain electrode of the first transistor.

10. The active matrix organic light emitting diode pixel circuit of claim 9, wherein the first to the seventh transistors are all N-type transistors.

11. The active matrix organic light emitting diode pixel circuit of claim 10, wherein:
the gate electrodes of the second and the fourth transistors are connected to a first selection wire;
the gate electrodes of the third and the sixth transistors are connected to a second selection wire;
the gate electrode of the fifth transistor is connected to a third selection wire; and
the gate electrode of the seventh transistor is connected to a fourth to selection wire.

12. The active matrix organic light emitting diode pixel circuit of claim 9, wherein the first, the second, the third, the fourth and the sixth transistors are N-type transistors, and the fifth and the seventh transistors are P-type transistors.

13. The active matrix organic light emitting diode pixel circuit of claim 12, wherein:
the gate electrodes of the second, the fourth and the fifth transistors are connected to a first selection wire; and
the gate electrodes of the third, the sixth and the seventh transistors are connected to a second selection wire.

14. An operating method of an active matrix organic light emitting diode pixel circuit, wherein the active matrix organic light emitting diode pixel circuit comprises an organic light emitting diode, a driving circuit, a switching circuit and a capacitor; the organic light emitting diode is connected to a first power source, the driving circuit is directly connected to a second power source or is electrically connected to the second power source through the switching circuit, the switching circuit is connected to a signal input terminal, the capacitor is connected into the switching circuit; and the operating method of the active matrix organic light emitting diode pixel circuit comprise the following steps:
(a) in a charge state, by controlling the switching circuit, a first end of the capacitor being electrically connected to the signal input terminal, and a second end of the capacitor being electrically connected to the first power source; or by controlling the switching circuit, the first end of the capacitor being electrically connected to the second power source, and the second end of the capacitor being electrically connected to the signal input terminal;
(b) in a compensation state, by controlling the switching circuit, the first end of the capacitor being electrically connected to the signal input terminal, and the second end of the capacitor being electrically connected to an anode of the organic light emitting diode; or by controlling the switching circuit, the first end of the capacitor being electrically connected to the anode of the organic light emitting diode, and the second end of the capacitor being electrically connected to the signal input terminal; and
(c) in an emission state, by controlling the switching circuit, the first end of the capacitor being electrically connected to the driving circuit, and the second end of the capacitor being electrically connected to the driving circuit and the anode of the organic light emitting diode.

15. The operating method of the active matrix organic light emitting diode pixel circuit of claim 14, wherein when the driving circuit is directly connected to the second power source:
the driving circuit is a first transistor, a first source/drain electrode of the first transistor is connected to the anode of the organic light emitting diode, and a second source/drain electrode of the first transistor is connected to the second power source;
the switching circuit comprises a second transistor, a third transistor, a fourth transistor and a fifth transistor, wherein a first source/drain electrode of the second transistor is connected to the first end of the capacitor and a first source/drain electrode of the third transistor, and a second source/drain electrode of the second transistor is connected to a gate electrode of the first transistor; a second source/drain electrode of the third transistor is connected to the signal input terminal; a first source/drain electrode of the fourth transistor is connected to the second end of the capacitor and a first source/drain electrode of the fifth transistor, and a second source/drain electrode of the fourth transistor is connected to the first source/drain electrode of the first transistor and the anode of the organic light emitting diode; and a second source/drain electrode of the fifth transistor is connected to the first power source; and
the step (a) comprises:
conducting the third and the fifth transistors, and shutting down the second and the fourth transistor, so that the voltage of the first end of the capacitor is the voltage of the signal input terminal, and the voltage of the second end of the capacitor is the voltage of the first power source.

16. The operating method of the active matrix organic light emitting diode pixel circuit of claim 15, wherein the step (b) comprises:
conducting the third and the fourth transistors, and shutting down the second and the fifth transistors, so that the capacitor discharges via the organic light emitting diode until no current flows through the organic light emitting diode.

17. The operating method of the active matrix organic light emitting diode pixel circuit of claim 16, wherein the step (c) comprises:
conducting the second and the fourth transistors, and shutting down the third and the fifth transistors, so that the first transistor drives the organic light emitting diode according to the potential difference between two ends of the capacitor.

18. The operating method of the active matrix organic light emitting diode pixel circuit of claim 14, wherein when the driving circuit is electrically connected to the first power source through the switching circuit:
the driving circuit is a first transistor, and a first source/drain electrode of the first transistor is connected to the anode of the organic light emitting diode;
the switching circuit comprises a second transistor, a third transistor, a fourth transistor, a fifth transistor, a sixth transistor and a seventh transistor, wherein a first source/drain electrode of the second transistor is connected to a second source/drain electrode of the first transistor and a first source/drain electrode of the third transistor, and a second source/drain electrode of the second transistor is connected to the second power source; a second source/drain electrode of the third transistor is connected to a gate electrode of the first transistor and a first source/drain electrode of the fourth transistor, and a second source/drain electrode of the fourth transistor is connected to a first end of the capacitor and a first source/drain electrode of the fifth transistor; a second source/drain electrode of the fifth transistor is connected to the anode of the organic light emitting diode, the first source/drain electrode of the first transistor and a second source/drain electrode of the seventh transistor; a first source/drain electrode of the sixth transistor is connected to the second end of the capacitor and a first source/drain electrode of the seventh transistor; and a to second source/drain electrode of the sixth transistor is connected to the signal input terminal; and
the step (a) comprises:
conducting the second, the third the fourth and the sixth transistors, and shutting down the fifth and the seventh transistors, so that the voltage of the first end of the capacitor is the voltage of the second power source, and the voltage of the second end of the capacitor is the voltage of the signal input terminal.

19. The operating method of the active matrix organic light emitting diode pixel circuit of claim 18, wherein the step (b) comprises:
conducting the third, the fifth and the sixth transistors, and shutting down the second, the fourth and the seventh transistors, so that the capacitor discharges via the organic light emitting diode until no current flows through the organic light emitting diode.

20. The operating method of the active matrix organic light emitting diode pixel circuit of claim 19, wherein the step (c) comprises: conducting the second, the fourth and the seventh transistors, and shutting down the third, the fifth and the sixth transistors, so that the first transistor drives the organic light emitting diode according to potential difference between two ends of the capacitor.
